(19) United States
(12) Patent Application Publication
(10) Pub. No.: US 2013/0103570 A1
(43) Pub. Date: Apr. 25, 2013

(54) SYSTEM AND METHOD FOR DETERMINING CREDIT QUALITY INDEX

(71) Applicants: HongQi Shi, Hawthorn Woods, IL (US); Shrikant Dash, Lincolnshire, IL (US); Vaibhav Bhatt, Chicago, IL (US)

(72) Inventors: HongQi Shi, Hawthorn Woods, IL (US); Shrikant Dash, Lincolnshire, IL (US); Vaibhav Bhatt, Chicago, IL (US)

(73) Assignee: Discover Financial Services, Riverwoods, IL (US)

(21) Appl. No.: 13/278,643

(22) Filed: Oct. 21, 2011

(51) Int. Cl. G06Q 40/00

(52) U.S. Cl. 705/38

(57) ABSTRACT

Electronic modeling of long-term historical financial credit performance of a consumer is described. A plurality of historical time periods originating from an observation point in time occurring in the past are established and a plurality of past credit performance snapshots for a sample consumer population are obtained. A credit risk management computer system computes a credit quality index for each of the past credit performance snapshots of the sample population and for a recent credit performance snapshot of the consumer. An overall credit quality index for the sample population spanning the plurality of historical time periods is likewise computed and a prediction of an overall credit quality index for the consumer spanning the plurality of historical time periods is made.

### FIELD OF THE INVENTION

This patent disclosure relates generally to electronic enterprise systems and more particularly to electronic credit risk management systems.

### BACKGROUND OF THE INVENTION

A credit situation of an individual at a point in time is affected by a myriad of factors, such as economic upswings or downturns, medical or personal situation, good or bad investments, among others. While these factors play an important role in describing the short-term risk profile of an individual, they would be inadequate in a long run and over a rapidly changing external environment.

For example, in an improving economy, individuals that are temporarily stressed but have long history of good credit performance are likely to show good credit performance going forward. Similarly, in a worsening economy, individuals that are currently non-delinquent, but have tainted credit history are likely to show poor credit performance going forward.

Conventional techniques for measuring credit risk do not take a long-term view into account. Such techniques are also limited to predicting a delinquency or loss outcome over a defined future outcome window. As such, conventional credit risk measuring techniques are not optimal for predicting long-term ability to manage credit due to being affected by short-term fluctuations in economic conditions, which may make it difficult for certain consumers to obtain credit during the times of economic recession.

It will be appreciated that this background description has been created by the inventor to aid the reader, and is not to be taken as a reference to prior art nor as an indication that any of the indicated problems were themselves appreciated in the art. While the described principles can, in some regards and embodiments, alleviate the problems inherent in other systems, it will be appreciated that the scope of the protected innovation is defined by the attached claims.

### SUMMARY OF THE INVENTION

In one aspect of the invention, a computer implemented method for electronically modeling, via a credit risk management computer system, a long-term historical financial credit performance of a consumer is provided. The method comprises establishing a plurality of historical time periods originating from an observation point in time occurring in the past, obtaining, at the credit risk management computer system, a plurality of past credit performance snapshots for a sample consumer population, each past credit performance snapshot corresponding to one of the plurality of historical time periods, obtaining, at the credit risk management computer system, a recent credit performance snapshot for the consumer, the recent credit performance snapshot for the consumer occurring outside of the plurality of historical time periods, computing, via the credit risk management computer system, a credit quality index for each of the past credit performance snapshots of the sample population and for the recent credit performance snapshot of the consumer, computing, via the credit risk management computer system, an overall credit quality index for the sample population spanning the plurality of historical time periods, the overall credit quality index for the sample population comprising a sum of the credit quality indexes for each past credit performance snapshot, and predicting an overall credit quality index for the consumer spanning the plurality of historical time periods based on the overall credit quality index for the sample population and the credit quality index corresponding to the recent credit performance snapshot of the consumer.

In another aspect of the invention, a non-transitory computer readable medium is provided, the computer readable medium having stored thereon computer executable instructions for electronically modeling a long-term historical financial credit performance of a consumer. The instructions comprise establishing a plurality of historical time periods originating from an observation point in time occurring in the past, obtaining, at the credit risk management computer system, a plurality of past credit performance snapshots for a sample consumer population, each past credit performance snapshot corresponding to one of the plurality of historical time periods. The instructions further comprise obtaining, at the credit risk management computer system, a recent credit performance snapshot for the consumer, the recent credit performance snapshot for the consumer occurring outside of the plurality of historical time periods, computing, via the credit risk management computer system, a credit quality index for each of the past credit performance snapshots of the sample population and for the recent credit performance snapshot of the consumer. The instructions further comprise computing, via the credit risk management computer system, an overall credit quality index for the sample population spanning the plurality of historical time periods, the overall credit quality index for the sample population comprising a sum of the credit quality indexes for each past credit performance snapshot, and predicting an overall credit quality index for the consumer spanning the plurality of historical time periods based on the overall credit quality index for the sample population and the credit quality index corresponding to the recent credit performance snapshot of the consumer.

In yet another aspect of the invention, a credit risk management computer system for electronically modeling a long-term historical financial credit performance of a consumer is provided. The system comprising a credit issuer computer system configured to establish a plurality of historical time periods originating from an observation point in time occurring in the past, and a credit information aggregation computer system configured to communicate to the credit issuer computer system (a) a plurality of past credit performance snapshots for a sample consumer population, each past credit performance snapshot corresponding to one of the plurality of historical time periods, and (b) a recent credit performance snapshot for the consumer, the recent credit performance snapshot for the consumer occurring outside of the plurality of historical time periods. The credit issuer computer system further configured to compute a credit quality index for each of the past credit performance snapshots of the sample population and for the recent credit performance snapshot of the consumer, and compute an overall credit quality index for the sample population spanning the plurality of historical time periods, the overall credit quality index for the sample population comprising a sum of the credit quality indexes for each past credit performance snapshot, wherein the credit issuer computer system predicts an overall credit quality index for the consumer spanning the plurality of historical time periods based on the overall credit quality index for the sample population and the credit quality index corresponding to the recent credit performance snapshot of the consumer.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic diagram showing a financial credit risk management computer system, in accordance with an embodiment of the invention;

FIG. 2 is a flow chart showing a method for electronically modeling, via a credit risk management computer system of FIG. 1, a long-term historical financial credit performance of a consumer, in accordance with an embodiment of the invention;

FIG. 3 is a schematic diagram of a timeline for modeling a long-term historical financial credit performance of a consumer, in accordance with an embodiment of the invention; and

FIG. 4 is a schematic diagram showing hardware components of the credit risk management computer system of FIG. 1, in accordance with an embodiment of the invention.

### DETAILED DESCRIPTION OF THE INVENTION

The following examples further illustrate the invention but, of course, should not be construed as in any way limiting its scope.

Embodiments of the invention provide a Credit Quality Index (CQI) that indicates a customer's long term credit performance. A credit performance model is created and executed in order to differentiate among categories of individuals that exhibit a variety of credit behaviors, such as—consistently good, good but temporarily stressed, volatile & risky, or consistently bad.

An assessment of long-term credit-worthiness of individuals provides a more stable measure of risk that supplements short-term credit situation. This assessment captures long-term ability to manage credit and is less likely to be affected by short-term situations. Preferably, embodiments of the credit risk modeling and assessment techniques described herein supplement existing risk scores that utilize short-term historical data (e.g., two-year or less than two-year data) and are trained to predict a future target variable. CQI supplements these scores by electronically configuring and modeling a long term historical risk index (e.g., over a 12-year economic cycle) which reflects a prospect's historical ability and willingness to pay in the past. In one embodiment, a 12-year window is selected because it covers a full economic cycle, for example starting with economic downturn of 2000-2001, followed by an intermediate growth period and ending with the downturn in 2008-2009.

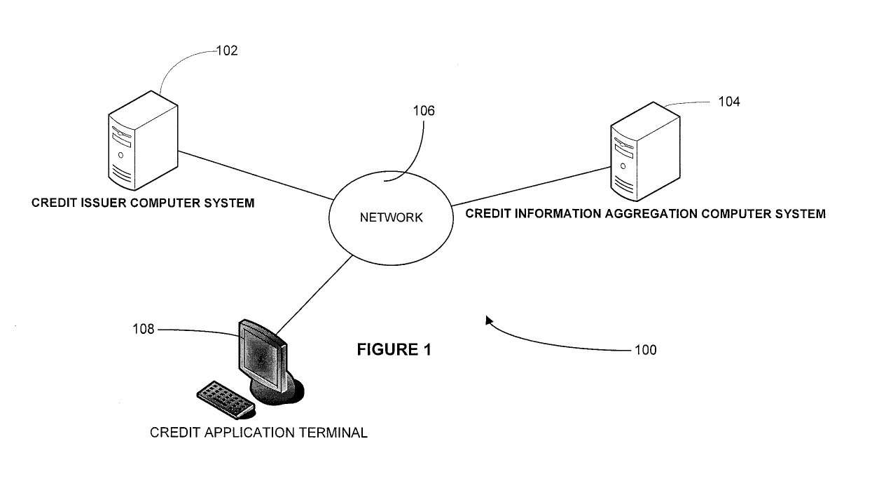

Turning to FIG. 1, an embodiment of a financial credit risk management computer system in accordance with the invention is shown. The system 100 includes a credit issuer computer system 102 in communication with one or more credit information aggregation and/or processing systems 104. In various embodiments, the credit information aggregation and/or processing system 104 may be external or internal to the credit issuer computer system 102 and includes a credit data provider system, such as a credit bureau computer system or the like. The system 100 further includes a computer network 106, such as the Internet, Local Area Network (LAN), Wide Area Network (WAN), Wireless Wide Area Network (WWAN) or the like, which provides the communication between the credit issuer computer system 102 and the credit information aggregation system 104. In an embodiment, the system 100 further includes a plurality of consumer and/or retail communication devices 108 (e.g., computers, mobile devices, or point of sale electronic terminals) connected to the network 106 for providing consumer credit information input, such as electronic credit applications. As those skilled in the art will realize, special-purpose computer systems 102, 104, as well as associated consumer communication devices, include computer processors executing computer readable instructions configured to perform the methods described in further detail below, where the instructions are stored on non-transitory computer readable media, such as hard drives, flash memory, RAM/ROM, or the like.

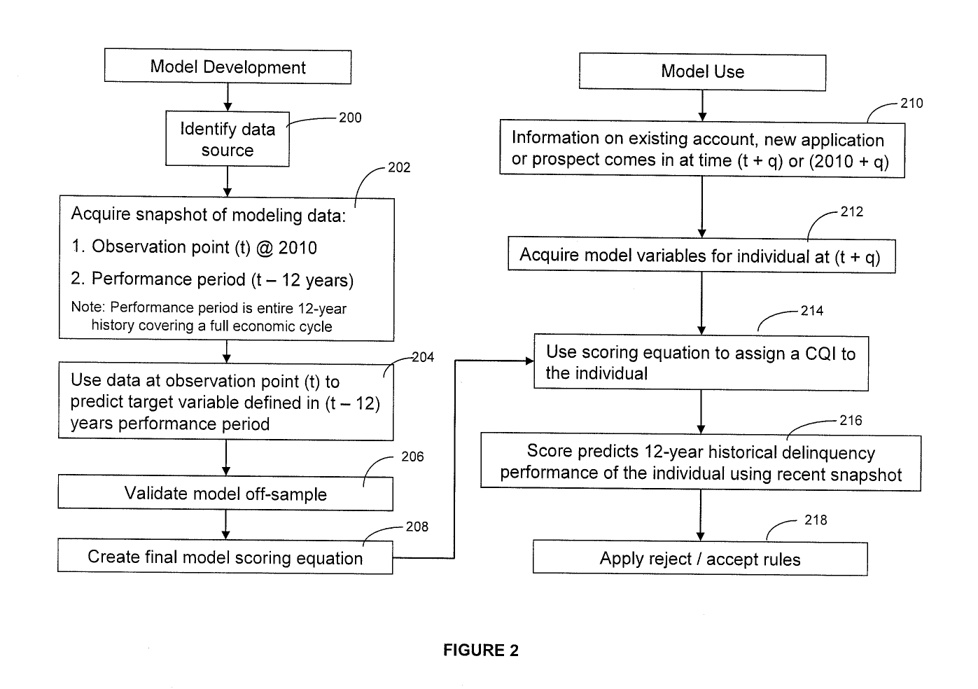

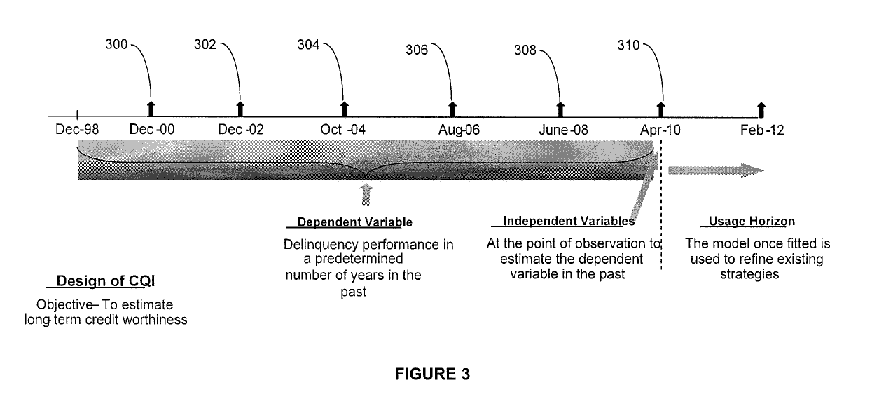

Turning to FIG. 2, an embodiment of a method for electronically modeling, via a credit risk management computer system of FIG. 1, a long-term historical financial credit performance of a consumer is shown. In step 200, the credit risk management computer system identifies a data source for modeling data. In one embodiment, historical credit bureau data for a sample consumer population is communicated from the credit information aggregation computer system 104 for use as the modeling data source. In step 202, an observation point in time is selected and a predetermined number of years in the past from the selected observation point is set as the historical credit performance period that preferably reflects a time span corresponding to a full economic cycle. In one embodiment, six (6) two year historical snapshots of credit bureau-sourced credit performance data of a sample population are used to represent a full twelve (12) year economic cycle of credit performance data for modeling purposes. The long-term historical focus for sample population data used for creating a credit performance model results in a model that takes into account a full economic cycle for predicting a prospect's historical (past) ability to pay throughout the economic cycle as an indicator of future creditworthiness. This approach has a further advantage of taking into account any short-term economic swings in credit performance data, such as by assigning weights to short-term fluctuations in credit performance throughout the historical economic cycle, as further discussed below. Model parameters and design are discussed in further detail with reference to FIG. 3 below. Returning to FIG. 2, in step 204 a data observation point in time (t) is used to predict the model target variable (comprising frequency, severity, and recency of delinquency, as well as associated weights to generate an index discussed below) occurring in (t−12) years historical performance period. In steps 206-208, the model parameters are validated by comparing the model output to known off-sample data and a final model scoring equation is generated by the financial credit risk management computer system of FIG. 1.

It will be appreciated that the foregoing steps 200-208 pertained to the model development process, while the following steps 210-218 pertain to model use. In step 210, the financial credit risk management computer system receives financial credit information, such as existing account credit information, or new credit application at a time (t+q) from the point of observation t. In step 212, the model variables specific to the individual credit application subject to evaluation are acquired. At this point, the model scoring equation is evaluated to assign a Credit Quality Index (CQI) to the individual, step 214 (discussed in detail in FIG. 3). In step 216, the model's score output predicts a twelve (12) year historical delinquency performance of the individual using the recent credit data snapshot acquired in step 210. Based on the modeled score predicted for the individual credit account holder or applicant, the financial credit risk management computer system applies predetermined acceptance rules to render a credit decision with respect to the individual.

Referring to FIG. 3, an embodiment of a timeline for modeling a long-term historical financial credit performance of a consumer is shown. In order to examine the overall long-term credit performance in the past, frequency, severity and recency of delinquency status were taken into account. A severe or frequent delinquent history indicates worse long term performance in the past and hence higher credit risk. Recency provides a mechanism to assign weights to different delinquencies in time. In the illustrated example of FIG. 3, the point of observation t is established at April 2010. Six two-year past credit performance snapshots for a sample credit consumer population are received from the credit information aggregation computer system 104 so as to reflect historical credit performance throughout a twelve year economic cycle (e.g., spanning through December 1998) and to determine a Credit Quality Index (CQI). Standing at each snapshot, the system analyzes the information in the last twenty four (24) months, which in its entirety covers a twelve year performance in the past. The following basic elements of CQI are considered:

Frequency (α): Frequency is the number occurrences of delinquency occurring among the six historical credit performance time intervals. At each snapshot, α=1 when delinquency occurred in the past twenty four months, otherwise α=0.

Severity (β): At each snapshot, severity of delinquency is determined by the worst (e.g., longest) delinquency occurring in the past 24 months. Preferably, a different weight is assigned corresponding to a particular delinquency status so as to differentiate its severity. For instance, thirty days past due (“30 dpd”) delinquency has the smallest weight value, while over one hundred fifty days past due (“150+ dpd”) has the highest weight value, with intermediate weights assigned to delinquencies occurring in between these time periods, as shown below. In an embodiment, the weights are assigned based on the observed rates at which delinquent balances flow to losses, as follows:
β=0, if the worst delinquency is 30 dpd;
β=0.24, if the worst delinquency is 60 dpd;
β=0.52, if the worst delinquency is 90 dpd;
β=0.90, if the worst delinquency is 120 dpd;
β=1, if the worst delinquency is 150+ dpd.

Additionally, Recency (γ) indicates how recent the delinquent behavior occurred. More recent delinquent behavior events have a greater effect on increasing the CQI index. Different recency weight is assigned to a particular two-year credit snapshot in accordance with the recency of delinquency therein, as shown in below embodiment:
γ=0.5, for the 1st snapshot, namely the least recent snapshot
γ=0.6, for the 2nd snapshot
γ=0.7, for the 3rd snapshot
γ=0.8, for the 4th snapshot
γ=0.9, for the 5th snapshot
γ=1, for the 6th snapshot, namely the most recent snapshot.

Hence, (CQI)ᵢ=αᵢ*βᵢ, from 1 to 6, where (CQI)ᵢ indicates the Credit Quality Index at each snapshot. The comprehensive long-term CQI with recency weight is calculated as follows:

$${CQI}_{12 year} = {\sum }_{i = 1}^{6} {CQI}_{i} * {γ}_{i}$$

$${CQI}_{10 year} = {\sum }_{i = 2}^{6} {CQI}_{i} * {γ}_{i}$$

$${CQI}_{8 year} = {\sum }_{i = 3}^{6} {CQI}_{i} * {γ}_{i}$$

In an embodiment, CQI has 60 distinct values, ranging from 0 to 4.5. Higher values of CQI indicate poor long-term credit performance in the past (e.g., past 8, 10, or 12 years as in above long-term CQI equations) and higher credit risk. In an embodiment, the long-term CQI is evaluated for periods of time corresponding to the duration of the credit performance data available for the sample population (e.g., 8, 10, or 12 year CQI). In further embodiments, the credit quality index includes additional weights that take into account the amount of a consumer credit balance during delinquency (e.g., greater balance during delinquency may be assigned a greater weight), as well as weights corresponding to a time of economic recession period (e.g., heavier or lighter weighting of known past recession periods depending upon the desired risk tolerance).

Model Design

In an embodiment, the model predicts a prospect's long-term credit quality in the past twelve (12) years. A continuous dependent variable, namely credit quality index (CQI) described above, is created for each individual. With this continuous dependent variable, a development sample consumer population is segmented and within each segment, logistic regression and nonparametric regression techniques are used to develop the model.

Among further distinguishing characteristics of the CQI model is a two step modeling approach that includes a logistic model on overall modeling population as first modeling step, and a generalized addictive model (GAM) on partial modeling population as a second modeling step. The final model output is then equal to the product of the output of the first and second modeling steps. This allows to take into account a characteristic of the dependent variables, namely that around 50% of the records have a CQI=0, which prevents an assumption of linear regression.

Unlike traditional models that use current information to predict future performance, the CQI credit performance model uses current information to mimic the long-term credit performance in the past (e.g., predicting a credit prospect's past credit performance over at least approximately an economic cycle time period). Referring again to FIG. 3, the current information from the sixth two-year credit performance snapshot 310 is used to model the historical CQI aggregated from first snapshot 300 (alternatively, from second or third snapshots 302, 304) through the fifth two-year credit performance snapshot 308 in order to avoid information overlap between dependent and independent variables. In other words, preferably, the recent credit performance snapshot 310 of the consumer occurs outside of the plurality of historical time periods 300-308. The final CQI is calculated as the sum of the modeled historical CQIs (e.g., from first snapshot 300 to fifth snapshot 308) and current CQI which was directly derived from the current information in the most recent credit performance snapshot 310.

Thus, in the modeling procedure, the first step involves the credit risk management computer system 100 modeling the probability (prob) of CQI not equaling to zero (0) by logistic regression. The second step involves the credit risk management computer system 100 modeling the estimated value (EstCQI) of CQI for a particular group whose CQI dose not equal to zero (0) by utilizing the generalized additive model (GAM). The historical CQI is then equal to the product of the probability of CQI not equaling zero and the estimated CQI as follows: CQIₕᵢₛₜ=prob*EstCQI, while the final CQI=CQIₕᵢₛₜ+CQI₆ₜₕ, as discussed above.

Dependent Variable Definition

To take into account varying availability of length of past credit history performance data for the sample population, different dependent variables are defined in each corresponding population. In one embodiment, a total of (3) models are developed with different dependent variables. The credit risk management computer system 100 then applies resealing and extrapolation to get the expected output, namely a 12-year long-term credit quality index. An embodiment of the definition of dependent and independent variables is shown in Table 1 below.

TABLE 1

| | | Population 1 | Population 2 | Population 3 |
|---|---|---|---|---|
| Length of Credit History | | >=10 years | 8-10 years | 6-8 years |
| Data Availability | | 6 snapshots | 5 snapshots | 4 snapshots |
| | | | (absence of 1^{st} snapshot) | (absence of 1^{st}, 2^{nd} snapshots) |
| | | 12-year performance | 10-year performance | 8-year performance |
| Independent | | Credit Bureau Variables at the 6ₜₕ snapshot: | | |
| | | In an embodiment, independent variables used as predictors comprise to the following categories: | | |
| | | 1. Credit Age | | |
| | | 2. Number of credit trades (credit outstanding/level of indebtedness) | | |
| | | 3. Delinquency performance | | |
| | | 4. Credit Inquiries | | |
| | | In further embodiments, non-credit bureau information, such as home-ownership and/or education | | |
| | | is also employed. | | |
| Stage 1 Model | Dependent | probability of CQI_s1 > 0 | probability of CQI_s2 > 0 | probability of CQI_s3 > 0 |
| (Logistic) | Population | All Modeling Sample | All Modeling Sample | All Modeling Sample |
| Stage 2 Model | Dependent | CQI_s1 | CQI_s2 | CQI_s3 |
| (GAM) | Population | CQI_s1 > 0 subgroup | CQI_s2 > 0 subgroup | CQI_s3 > 0 subgroup |
| Stage 1 * Stage 2 | Formula | prob1* EstCQI_s1 + CQI₆ₜₕ | prob2* EstCQI_s2 + CQI₆ₜₕ | prob3* EstCQI_s3 + CQI₆ₜₕ |
| Output | Description | 12-year CQI | 10-year CQI | 8-year CQI |
| | | (from 1^{st} to 6^{th} snapshot) | (From 2^{nd} to 6^{th} snapshot) | (From 3^{rd} to 6^{th} snapshot) |

Where:
$CQI\_s 1 = {\sum }_{i = 1}^{5} {CQI}_{i} * {γ}_{i} ;$ $CQI\_s 2 = {\sum }_{i = 2}^{5} {CQI}_{i} * {γ}_{i} ;$ $CQI\_s 3 = {\sum }_{i = 3}^{5} {CQI}_{i} * {γ}_{i} ;$ γ is the recency weight; and
CQIᵢ is the i^{th} CQI considering the severity of default, as discussed above.

In an embodiment, the independent variables include credit bureau variables at the sixth (most recent) credit performance snapshot of the consumer, such as an occurrence of a credit delinquency, a number of days past due associated with the credit delinquency, and a date of the occurrence of the credit delinquency, among other credit bureau variables. These credit-bureau variables further include the categories reported by the credit-bureaus, such as credit age, number of credit trades (indicative of credit outstanding or level of indebtedness), delinquency performance, and credit inquiries. In further embodiments, independent variables also include non-credit bureau information, such as home-ownership and/or education status.

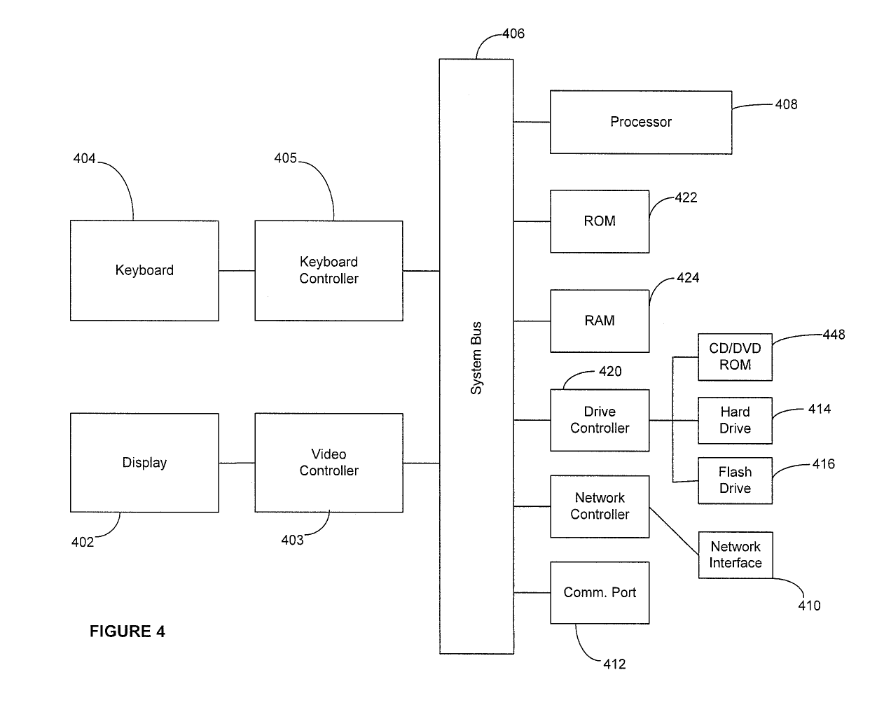

Turning to FIG. 4, an embodiment of hardware components of the credit risk management computer system 100 configured for implementing embodiments of the invention described herein is shown with reference to a computing device 400. Those skilled in the art will realize that the credit risk management computer system 100 may include one or more computing devices described herein. The computing device 400, such as a computer, including a dedicated special-purpose automated credit risk modeling and evaluation device, includes a plurality of hardware elements, including a display 402 and a video controller 403 for presenting to the user an interface for interacting with the credit performance modeling computer-based algorithm implemented in accordance with embodiments described herein. The computing device 400 further includes a keyboard 404 and keyboard controller 405 for relaying the user input via the user interface. Alternatively or in addition, the computing device 400 includes a tactile input interface, such as a touch screen. The display 402 and keyboard 404 (and/or touch screen) peripherals connect to the system bus 406. A processor 408, such as a central processing unit (CPU) of the computing device or a dedicated special-purpose credit risk modeling processor, executes computer executable instructions comprising embodiments of the electronic modeling of long-term historical financial credit performance of a consumer, as described above. In embodiments, the computer executable instructions are received over a network interface 410 (or communications port 412) or are locally stored and accessed from a non-transitory computer readable medium, such as a hard drive 414, flash (solid state) memory drive 416, or CD/DVD ROM drive 418. The computer readable media 414-418 are accessible via the drive controller 420. Read Only Memory (ROM) 422 includes computer executable instructions for initializing the processor 408, while the Random Access Memory (RAM) 424 is the main memory for loading and processing instructions executed by the processor 408.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer implemented method for electronically modeling, via a credit risk management computer system, a long-term historical financial credit performance of a consumer, the method comprising:
establishing a plurality of historical time periods originating from an observation point in time occurring in the past;
obtaining, at the credit risk management computer system, a plurality of past credit performance snapshots for a sample consumer population, each past credit performance snapshot corresponding to one of the plurality of historical time periods;
obtaining, at the credit risk management computer system, a recent credit performance snapshot for the consumer, the recent credit performance snapshot for the consumer occurring outside of the plurality of historical time periods;
computing, via the credit risk management computer system, a credit quality index for each of the past credit performance snapshots of the sample population and for the recent credit performance snapshot of the consumer;
computing, via the credit risk management computer system, an overall credit quality index for the sample population spanning the plurality of historical time periods, the overall credit quality index for the sample population comprising a sum of the credit quality indexes for each past credit performance snapshot; and
predicting an overall credit quality index for the consumer spanning the plurality of historical time periods based on the overall credit quality index for the sample population and the credit quality index corresponding to the recent credit performance snapshot of the consumer.

2. The method of claim 1 wherein the credit quality index comprises: (a) a number of occurrences of a delinquency at a corresponding credit performance snapshot weighted by (b) a numeric indicator of a severity of the delinquency within the corresponding credit performance snapshot, further weighted by (c) a numeric indicator of a recency of the delinquency within the corresponding credit performance snapshot.

3. The method of claim 2 wherein the credit quality index is further based on a weighted consumer credit balance during delinquency and a weight corresponding to a time of economic recession period.

4. The method of claim 1 wherein at least one of the past credit performance snapshot of the sample consumer population and the recent credit performance snapshot of the consumer comprises credit bureau data indicative of an occurrence of a credit delinquency, a number of days past due associated with the credit delinquency, and a date of the occurrence of the credit delinquency.

5. The method of claim 1 wherein computing the overall credit quality index for the sample population further comprises:
computing a product of: (a) a probability that the credit quality index of a group of consumers within the sample population is greater than zero and (b) an estimate of the credit quality index for the group of consumers.

6. The method of claim 1 further comprising making a credit underwriting decision based on the predicted overall credit quality index for the consumer.

7. A non-transitory computer readable medium having stored thereon computer executable instructions for electronically modeling a long-term historical financial credit performance of a consumer, the instructions comprising:
establishing a plurality of historical time periods originating from an observation point in time occurring in the past;
obtaining, at the credit risk management computer system, a plurality of past credit performance snapshots for a sample consumer population, each past credit performance snapshot corresponding to one of the plurality of historical time periods;
obtaining, at the credit risk management computer system, a recent credit performance snapshot for the consumer, the recent credit performance snapshot for the consumer occurring outside of the plurality of historical time periods;
computing, via the credit risk management computer system, a credit quality index for each of the past credit performance snapshots of the sample population and for the recent credit performance snapshot of the consumer;
computing, via the credit risk management computer system, an overall credit quality index for the sample population spanning the plurality of historical time periods, the overall credit quality index for the sample population comprising a sum of the credit quality indexes for each past credit performance snapshot; and
predicting an overall credit quality index for the consumer spanning the plurality of historical time periods based on the overall credit quality index for the sample population and the credit quality index corresponding to the recent credit performance snapshot of the consumer.

8. The computer readable medium of claim 7 wherein the credit quality index comprises: (a) a number of occurrences of a delinquency at a corresponding credit performance snapshot weighted by (b) a numeric indicator of a severity of the delinquency within the corresponding credit performance snapshot, further weighted by (c) a numeric indicator of a recency of the delinquency within the corresponding credit performance snapshot.

9. The computer readable medium of claim 8 wherein the credit quality index is further based on a weighted consumer credit balance during delinquency and a weight corresponding to a time of economic recession period.

10. The computer readable medium of claim 7 wherein at least one of the past credit performance snapshot of the sample consumer population and the recent credit performance snapshot of the consumer comprises credit bureau data indicative of an occurrence of a credit delinquency, a number of days past due associated with the credit delinquency, and a date of the occurrence of the credit delinquency.

11. The computer readable medium of claim 7 wherein computing the overall credit quality index for the sample population further comprises:
computing a product of: (a) a probability that the credit quality index of a group of consumers within the sample population is greater than zero and (b) an estimate of the credit quality index for the group of consumers.

12. The computer readable medium of claim 7 wherein the instructions further comprise making a credit underwriting decision based on the predicted overall credit quality index for the consumer.

13. A credit risk management computer system for electronically modeling a long-term historical financial credit performance of a consumer, the system comprising:
a credit issuer computer system configured to establish a plurality of historical time periods originating from an observation point in time occurring in the past; and
a credit information aggregation computer system configured to communicate to the credit issuer computer system:
(a) a plurality of past credit performance snapshots for a sample consumer population, each past credit performance snapshot corresponding to one of the plurality of historical time periods; and
(b) a recent credit performance snapshot for the consumer, the recent credit performance snapshot for the consumer occurring outside of the plurality of historical time periods;
the credit issuer computer system further configured to compute a credit quality index for each of the past credit performance snapshots of the sample population and for the recent credit performance snapshot of the consumer, and compute an overall credit quality index for the sample population spanning the plurality of historical time periods, the overall credit quality index for the sample population comprising a sum of the credit quality indexes for each past credit performance snapshot;
wherein the credit issuer computer system predicts an overall credit quality index for the consumer spanning the plurality of historical time periods based on the overall credit quality index for the sample population and the credit quality index corresponding to the recent credit performance snapshot of the consumer.

14. The system of claim 13 wherein the credit quality index comprises: (a) a number of occurrences of a delinquency at a corresponding credit performance snapshot weighted by (b) a numeric indicator of a severity of the delinquency within the corresponding credit performance snapshot, further weighted by (c) a numeric indicator of a recency of the delinquency within the corresponding credit performance snapshot.

15. The system of claim 14 wherein the credit quality index is further based on a weighted consumer credit balance during delinquency and a weight corresponding to a time of economic recession period.

16. The system of claim 13 wherein at least one of the past credit performance snapshot of the sample consumer population and the recent credit performance snapshot of the consumer comprises credit bureau data indicative of an occurrence of a credit delinquency, a number of days past due associated with the credit delinquency, and a date of the occurrence of the credit delinquency.

17. The system of claim 13 wherein the credit issuer computer system computes the overall credit quality index for the sample population by computing a product of: (a) a probability that the credit quality index of a group of consumers within the sample population is greater than zero and (b) an estimate of the credit quality index for the group of consumers.

18. The system of claim 13 wherein the credit issuer computer system is further configured to automatically make a credit underwriting decision based on the predicted overall credit quality index for the consumer.
